(19) United States
(12) Patent Application Publication
(10) Pub. No.: US 2012/0050767 A1
(43) Pub. Date: Mar. 1, 2012

(54) GAMUT SHAPE PREDICTION METHOD, GAMUT SHAPE PREDICTION PROGRAM, AND PRINTING APPARATUS LOADED WITH COLOR CONVERSION TABLE GENERATED USING GAMUT PREDICTED BY GAMUT SHAPE PREDICTION METHOD

(75) Inventor: Takashige TANAKA, Matsumoto-shi (JP)

(73) Assignee: SEIKO EPSON CORPORATION, Tokyo (JP)

(21) Appl. No.: 13/217,019

(22) Filed: Aug. 24, 2011

(30) Foreign Application Priority Data
Aug. 26, 2010 (JP) 2010-189930

(51) Int. Cl. H04N 1/60; G06K 9/00

(52) U.S. Cl. 358/1.9; 382/162

(57) ABSTRACT

A gamut shape prediction method of predicting a shape of a gamut expressed on a predetermined color space for an output apparatus includes: forming a plurality of target data which represents a cross-section surface along a first axis in the predetermined color space where the gamut is formed and which is used to search for boundary points of the gamut; calculating the boundary points of the target data by setting all boundary points of the target data located above or below along the first axis as references; and predicting the shape of the gamut from the calculated boundary points of each target data.

Priority is claimed under 35 U.S.C §119 to Japanese Application No. 2010-189930 filed on Aug. 26, 2010 which is hereby incorporated by reference in its entirety.

### BACKGROUND

1. Technical Field

The present invention relates to a gamut shape prediction method, a gamut shape prediction program, and a printing apparatus loaded with a color conversion table generated using a gamut predicted by the gamut shape prediction method.

2. Related Art

When image data is transmitted from an input apparatus to an output apparatus, it is necessary to perform color management (referred to as CMS) of absorbing a difference between color spaces in that the color spaces are different in the input and output apparatuses. For example, when image data is transmitted from a client PC to a printing apparatus, it is necessary to convert the color space (for example, sRGB system) used in the client PC into ink amounts (CMYK system) of ink used in the printing apparatus. In order to realize the color management, there is known a method of using a color conversion table (also referred to as an LUT) that defines a relationship between both color spaces.

Here, when the color conversion table is generated, a correspondence relationship between the values of sRGB and CMYK is not a one-to-one relationship and thus the correspondence relationship that defines a color conversion table is determined in consideration of an ink amount duty limit or a graininess index limit or the like. Further, since a color reproduction area (gamut) is different between the input apparatus and the output apparatus, it is necessary to add the gamut of the output apparatus in a generation procedure of the color conversion table (for example, JP-A-2009-33239).

As described above, an optimum solution is calculated in consideration of the conditions of the ink amount duty limit or the like in the generation procedure of the color conversion table. However, the gamut defined in the generated color conversion table has to fall within a predetermined evaluation range. For this reason, when the gamut generated based on the generated color conversion table does not fall within the evaluation range, it is necessary to generate the color conversion table again. Therefore, there is a concern that the number of processes or processing time necessary for generating the color conversion table may increase. Further, a given output apparatus has a gamut having a shape of which ends are diverged. Therefore, even in regard to this gamut, there is a necessity to predict the shape of the gamut with high precision.

### SUMMARY

An advantage of some aspects of the invention is that it provides a technique for reducing the number of processes and processing time necessary for generating a color conversion table by appropriately predicting a gamut before the color conversion table is generated.

According to an aspect of the invention, there is provided a gamut shape prediction method of predicting a shape of a gamut expressed on a predetermined color space for an output apparatus. The gamut shape prediction method includes: forming a plurality of target data which represents a cross-section surface along a first axis in the predetermined color space where the gamut is formed and which is used to search for boundary points of the gamut; calculating the boundary points of the target data by setting all boundary points of the target data located above or below along the first axis as references; and predicting the shape of the gamut from the calculated boundary points of each target data.

According to this aspect of the invention, the plurality of target data is first formed which represents a cross-section surface along a first axis in the predetermined color space where the gamut is formed and which is used to search for boundary points of the gamut. Subsequently, the boundary points of the target data are calculated by setting all boundary points of the target data located above or below along the first axis as references. Therefore, even when a boundary of the target data where the gamut is diverged is divided, all the lattice points can be searched and the boundary points can be calculated accurately by setting the boundary points of the target data located above or below along the first axis as the references. Further, since the shape of the gamut can be predicted accurately from the calculated boundary points of each target data, it is possible to reduce the number of processes and processing time when the color conversion table is generated.

As an example of the process very suitable for the calculating of the boundary points, in the calculating of the boundary points, the boundary points may be calculated by performing an internal and external determination process of setting, as start points, lattice points perpendicular in a direction of the first axis and all the boundary points of the target data located above or below in the direction of the first axis and determining whether each start point and lattice points around each start point exist inside or outside the gamut.

Further, as an example of the process very suitable for the calculating of the boundary points, in the calculating of the boundary points, results of the internal and external determination process performed on the respective lattice points may be recorded and used in subsequent searching of the boundary points of the same target data.

With such a configuration, the number of lattice points subjected to the internal and external determination process can be reduced as the internal and external determination process is performed. Therefore, it is possible to shorten the time necessary for predicting the shape of the gamut.

The color space may be an L*a*b* color space and the first axis may be an L* axis. The calculating of the boundary points may be performed in a high brightness area and a low brightness area.

Since the area where the gamut is diverged is a high brightness area or a low brightness area in many cases, the processes according to the aspect of the invention are performed only in the high brightness area or the low brightness area. Therefore, the processes may be performed faster in an intermediate brightness area. By realizing the above configuration, it is possible to optimally maintain balance between the time necessary for the processes and a prediction precision.

As an example suitable for the aspect of the invention, when the output apparatus satisfies a condition where a range of the gamut increases, an interval of the target data for searching for the boundary points may be enlarged.

For example, when many kinds of ink are used in the output apparatus, color reproduction is improved compared to a case where few kinds of ink are used. Therefore, the range of the gamut increases. Likewise, when the output apparatus is a printing apparatus, the range of the gamut also increases depending on the kinds of sheet used in the printing apparatus. Here, when the range of the gamut increases, a considerably varied area becomes small. Therefore, according to the aspect of the invention, when the output apparatus satisfies the condition where the range of the gamut is enlarged, it is possible to shorten the time necessary for predicting the shape of the gamut by enlarging the boundary search interval.

According to another aspect of the invention, as well as the gamut shape prediction method, there are provided a program causing a computer to execute the gamut shape prediction method according to the above aspect of the invention and a printing apparatus including a color conversion table formed using the gamut predicted by the gamut shape prediction method is used.

### BRIEF DESCRIPTION OF THE DRAWINGS

The invention will be described with reference to the accompanying drawings, wherein like numbers reference like elements.

FIG. 1 is a block diagram illustrating the configuration of a printing system.

FIG. 2 is a flowchart of an overall processing order in which a base LUT is generated.

FIG. 3 is a diagram illustrating an FM converter and an inverse model initial LUT.

FIG. 4 is a diagram illustrating a method of generating a color correction LUT based on the base LUT.

FIG. 5 is a diagram illustrating an example of the configuration of a gamut prediction unit.

FIG. 6 is a flowchart of a gamut prediction process (step S500 of FIG. 2) according to an embodiment.

FIGS. 7A and 7B are schematic diagrams illustrating a part of an integrated gamut.

FIG. 8 is a diagram illustrating a variation in the outline of the integrated gamut.

FIG. 9 is a flowchart of a process performed in step S540 of FIG. 6.

FIGS. 10A to 10C are diagrams illustrating a method of setting a search interval in a step S540.

FIG. 11 is a schematic diagram of an overview of an internal and external determination process.

FIG. 12 is a perspective view illustrating a part of a high brightness area of the integrated gamut.

FIG. 13 is a flowchart of a process performed in step S550 of FIG. 6 according to a second embodiment.

FIGS. 14A and 14B are diagrams of a boundary search process performed according to the second embodiment.

FIGS. 15A and 15B are diagrams of an internal and external determination process according to the second embodiment.

### DESCRIPTION OF EXEMPLARY EMBODIMENTS

Hereinafter, embodiments of the invention will be described in the following sequence.

### 1. First Embodiment

### 1.1. Configuration of Printing System

### 1.2. Processing Order of Generating Base LUT

### 1.3. Prediction of Gamut Shape

### 1.4. Internal and External Determination Process

### 1.5. Modified Example 1

### 1.6. Modified Example 2

### 2. Second Embodiment

### 3. Other Embodiments

### 1. First Embodiment

### 1.1. Configuration of Printing System

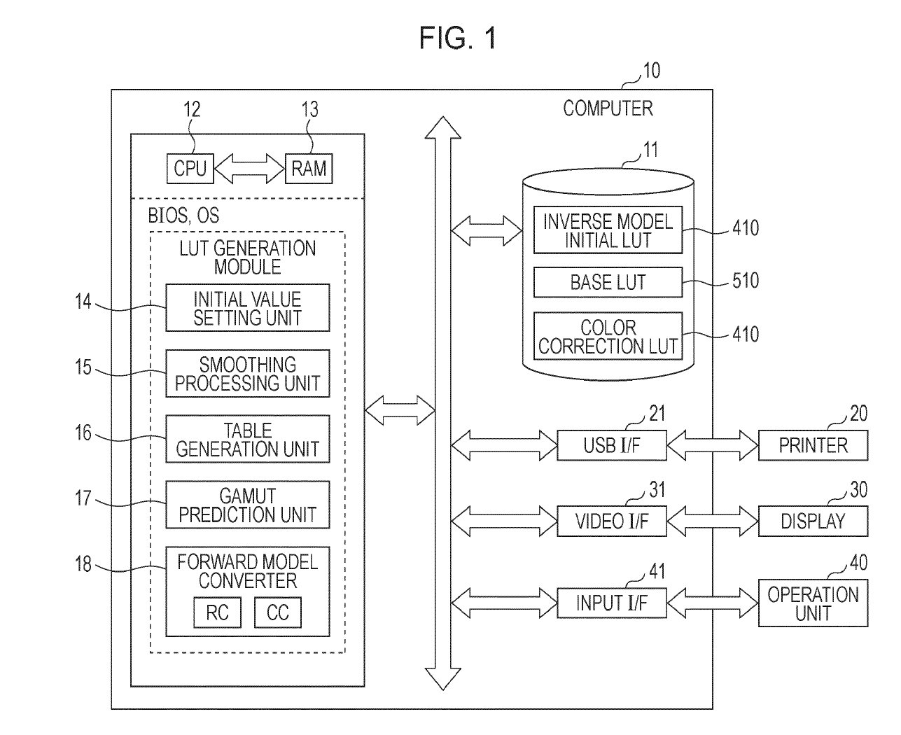

FIG. 1 is a block diagram illustrating the configuration of a printing system. The printing system includes a computer 10, a printer 20, a display 30, and an operation unit 40. The computer 10 includes a storage unit 11, a CPU 12, a RAM 13, a USB interface (I/F) 21, a video I/F 31, and an input I/F 41. The CPU 12 of the computer 10 realizes each function of an LUT generation module or the like by reading the program stored in the storage unit 11, developing the program on the RAM 13, and executing an arithmetic operation in accordance with a program. Each function of the LUT generation module will be described below.

The storage unit 11 is, for example, a hard disk drive (HDD) and stores programs, color conversion profiles (for example, an inverse model initial LUT 410, a base LUT 510, and a color correction LUT 610, and the like described below), or the like. Further, a lookup table is abbreviated as “LUT”. The base LUT 510 is a color conversion table that converts gray scale values of a predetermined input color space (for example, an RGB color space) into a combination (hereinafter, also referred to as an ink amount set) of plural kinds of ink used in the printer 20. The RGB color space, which is the input color space of the base LUT 510, is not a so-called device-dependent color space but a virtual color space (or an abstract color space) that is set irrespective of a specific device. The base LUT 510 is used, for example, when the color correction LUT 610 is generated. The name “base LUT” is originated in that this LUT is used as a base for generation of a color correction LUT. The color correction LUT 610 is a lookup table that converts a standard device-dependent color space (for example, the sRBG color space or the JAPAN COLOR 2001 color space) into ink amounts of a specific printer. The inverse model initial LUT 410 will be described below.

The computer 10 functions as a print control apparatus or the like by executing an arithmetic operation in accordance with a program and controlling the printer 20 serving as a printing apparatus via the USB I/F 21 or the like. Specifically, the computer 10 acquires image data to be printed, performs color conversion on the image data in a pixel unit based on a color conversion profile (the base LUT 510 or the like), and generates print data by performing a halftone process or a microwave process on the image data subjected to the color conversion. Then, the computer 10 outputs the print data to the printer 20 via the USB I/F 21 or the like. The printer 20 performs printing based on the print data. The computer 10 and the printer 20 may be connected to each other by another interface such as infrared rays or a wired LAN.

The computer 10 is connected to the display 30 via the video I/F 31 and is connected to the operation unit 40 such as a keyboard or a mouse via the input I/F 41.

The base LUT generation module of the computer 10 includes an initial value setting unit 14, a smoothing processing unit 15, a table generation unit 16, a gamut prediction unit 17, and a forward model converter 18. The functions of these units will be described below.

### 1.2. Processing Order of Generating Base LUT

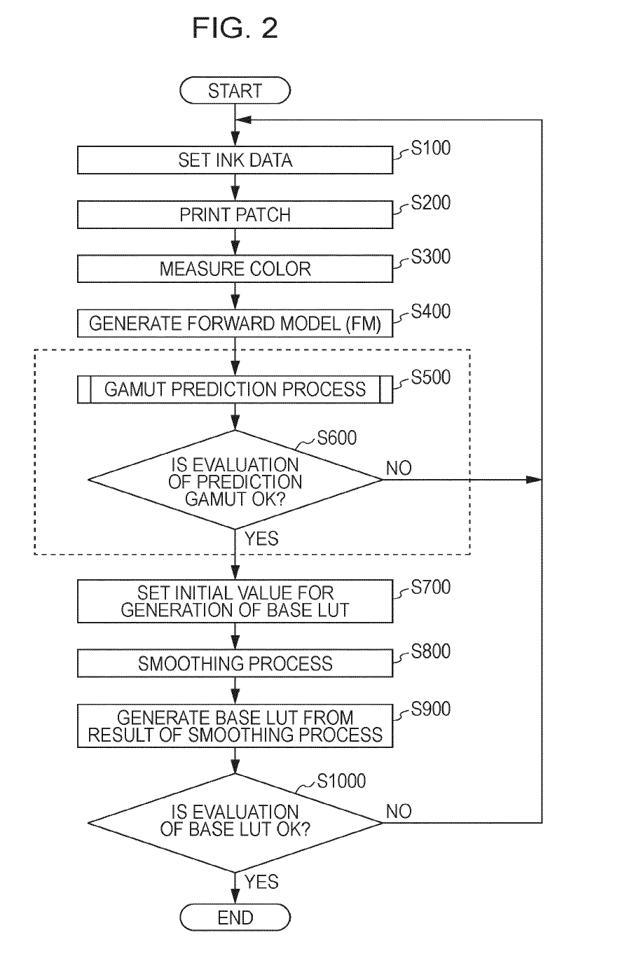

FIG. 2 is a flowchart of the overall processing order in which the base LUT is generated.

In step S100, ink data is set. Here, the ink data refers to the color, kind, duty limit value, or the like of ink used in the printer 20. In this embodiment, it is assumed that a color printer (the printer 20) can use eight kinds of ink: cyan (C), magenta (M), yellow (Y), black (K), light cyan (Lc), light magenta (Lm), light black (Lk), and light-light black (LLk).

The duty limit value refers to an amount of ink landed within a unit area of a medium (for example, a paper sheet). The duty limit values depend on a kind of medium or a resolution of an image to be formed. Therefore, the duty limit values are determined depending on each kind of medium (for example, a paper sheet) and a print resolution. In this embodiment, it is assumed that printing is performed on a photo sheet with the resolution of 1440×1440 dpi. Further, the duty limit values include a duty limit value of monochromatic ink and a duty limit value (sum duty limit value) of a sum of plurality of colors. For example, the duty limit values for a resolution of a given paper sheet are determined as 80% and 120% in the monochromatic color and the sum of respective colors, respectively.

In step S200, color patch printing is performed. Here, the color patch printing is performed by a simple combination of ink amounts without using the duty limit values or the color conversion table. In this embodiment, the term “color patch” is not limited to a chromatic color patch, but has a broad meaning that an includes achromatic color patch.

In step S300, the colors of the color patch are measured using, for example, a color measurer or a scanner (not shown). The color measurement result is transmitted to the computer 10. In the computer 10, a virtual sample in which the ink amounts correspond to color measurement values (L*a*b*) is formed.

In step S400, a forward model (hereinafter, also referred to as an FM) is generated based on the color measurement result (virtual sample) of the color patch. Here, the “forward model” refers to a conversion model which converts an ink amount into a color value (color measurement value) of a device-independent color space. On the contrary, an “inverse model” refers to a conversion model which converts a color value of a device-independent color space into an ink amount. In this embodiment, a CIE-L*a*b* color space is used as the device-independent color space (corresponding to a second color space). Hereinafter, a color value of the CIE-L*a*b* color space is simple referred to as a “L*a*b value” or a “Lab value”.

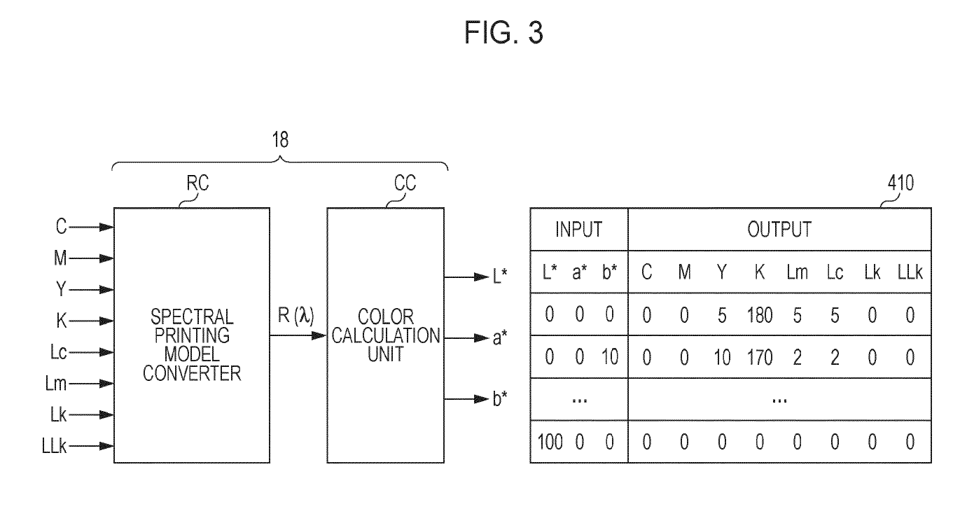

FIG. 3 is a diagram illustrating an FM converter and an inverse model initial LUT. As shown in FIG. 3, a spectral printing model converter RC that constitutes the front stage of the FM converter 18 converts the ink amounts of plural kinds of ink into spectral reflectivity R(λ) of the color patch printed in accordance with the ink amounts. In this embodiment, since it is assumed that the printer 20 uses the ink of the above-mentioned eight colors, the spectral printing model converter RC also inputs the ink amounts of the eight kinds of ink. However, any ink set may be used as the plural kinds of ink used in the printer 20. A color calculation unit CC calculates the color value of the L*a*b* color space from the spectral reflectivity R(λ). In the calculation of the color value, a light source (for example, the standard light D50) selected in advance is used as an observation condition of the color patch. For example, a method disclosed in JP-T-2007-511175 may be used as a method of generating the spectral print model converter RC.

The inverse model initial LUT 410 is a lookup table in which the ink amount is output when the L*a*b* value is input. In the inverse model initial LUT 410, for example, the L*a*b* space is divided into a plurality of small cells and the optimum ink amount is selected and registered for each small cell. For example, the optical ink amount is selected in consideration of the image quality of the color patch printed with this ink amount. In general, there are a plurality of combinations of the ink amounts with which a given one L*a*b* value is reproduced. Therefore, in the inverse model initial LUT 410, the ink amount selected as the optimum ink amount from the desired viewpoint such as an image quality is registered among the combination of the plurality of ink amounts for reproducing substantially the same L*a*b* value. The L*a*b* value which is an input value of the inverse model initial LUT 410 is the representative value of each small cell. On the other hand, the ink amount, which is an output value, is an ink amount with which a few of L*a*b* values in the small cell are reproduced. Thus, in the inverse model initial LUT 410, the L*a*b* value as an input value and the ink amount as an output value do not precisely correspond to each other. When the ink amount as the output value is converted into the L*a*b* value by the FM converter 18, the ink amount as the output value may differ from the input value of the inverse model initial LUT 410. However, an LUT in which the input values and the output values completely correspond to each other may be used as the initial LUT 410. Further, the base LUT may be generated without using the initial LUT 410. For example, the method disclosed in JP-T-2007-511175 may be used as a method of selecting the optimum ink amount for each small cell and generating the inverse model initial LUT 410.

In step S500 of FIG. 2, a gamut is predicted using the forward model (FM) and the ink duty limit values. The details of the prediction of the gamut will be described below.

In step S600, the gamut (hereinafter, also referred to as prediction gamut) predicted in step S500 is evaluated. The evaluation of the prediction gamut is executed by, for example, a user. When the evaluation of the prediction gamut is NG (NO in S600), the process returns to step S100.

On the other hand, when the evaluation of the prediction gamut is OK (YES in S600), an initial input value for generation of the base LUT is set by the user in step S700.

Substantially equal interval values predetermined as the respective values of the RGB are set as the input values of the base LUT 510. Since it is considered that a pair of RGB values represents a dot inside the RGB color space, the pair of RGB values is also referred to as an “input lattice point”.

In step S700, the initial values of the ink amounts for a few of input lattice points selected in advance from the plurality of input lattice points are input by the user. As the input lattice points for which the initial input values are set, it is preferable to select at least the input lattice points corresponding to apexes of a three-dimensional color solid in the RGB color space. In the apexes of the three-dimensional color solid, the respective values of RGB have the minimum value or the maximum value of the definition range. Specifically, when the respective values of the RGB are represented by eight bits, the initial input values of the ink amounts are set for the eight input lattice points which are (R, G, B)=(0, 0, 0), (0, 0, 255), (0, 255, 0), and (255, 0, 0). Further, the ink amounts for the input lattice points of (R, G, B)=(255, 255, 255) are set as all 0. Any initial input value is set for the ink amount of the other input lattice points. For example, the initial input value is set to 0.

In step S800 of FIG. 2, the smoothing processing unit 15 (see FIG. 1) performs a smoothing process based on the initial input values set in step S700.

The reason for performing the smoothing process in the L*a*b* space at the time of generating the base LUT 510 is as follows. That is, in the base LUT 510, there is a necessity to set the ink amounts of an output color space so as to reproduce a larger color gamut. A color gamut producible with a specific ink set is determined in consideration of a predetermined limit condition such as ink duty limit values (limit value of the ink amount that can be ejected in a given area). On the other hand, the above-described forward model FM is generated without consideration of this limit condition irrespective of the reproducible color gamut. Therefore, when the ranges of color points in the L*a*b* space are determined in consideration of the limit condition such as the ink duty limit values in the smoothing process, it is possible to determine the color gamut reproducible with a specific ink set. For example, an algorithm using a dynamic model is used as an algorithm that performs movement of the color points.

In step S900 of FIG. 2, the table generation unit 16 generates the base LUT 510 based on the result of the smoothing process. That is, the table generation unit 16 registers the optimum ink amounts that are optimum for reproducing the color points of the L*a*b* color space that can correspond to the input lattice points, respectively, as the output values of the base LUT 510.

In step S1000 of FIG. 2, the base LUT 510 is evaluated. When the evaluation is NG (NO in step S1000), the process returns to step S100 again. On the other hand, when the evaluation is OK, the base LUT 510 is registered in the storage unit 11.

The LUT generation module also generates the color correction LUT 610 based on the base LUT 510.

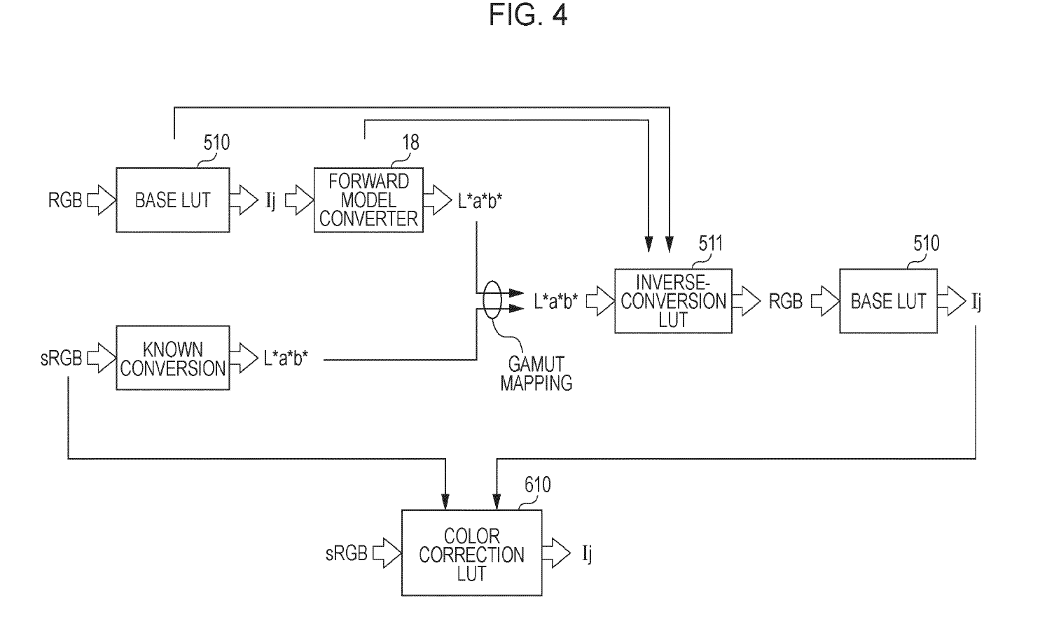

FIG. 4 is a diagram illustrating a method of generating the color correction LUT based on the base LUT. As shown in FIG. 4, the base LUT 510 converts the RGB values into ink amounts Ij. The ink amounts Ij represent the ink amount of the eight kinds of ink used in the printer 20. At this time, the suffixes j of the ink amounts Ij are 1 to 8. The converted ink amounts Ij are converted into the L*a*b* values by the FM converter 18. On the other hand, the sRGB values are converted into the L*a*b* values by a given conversion expression. Gamut mapping is performed so that the color gamut of the converted L*a*b* values is identical with the color gamut of the L*a*b* values converted by the FM converter 18. On the other hand, the L*a*b* values converted from the RGB values are used to generate an inverse conversion LUT 511 as an inverse direction lookup table through the base LUT 510 and the FM converter 18. The L*a*b* values subjected to the gamut mapping are converted into the RGB values by the inverse conversion LUT 511. The RGB values are converted again into the ink amount Ij by the base LUT 510. The color correction LUT 610 is generated by registering the correspondence relationship between the final ink amounts Ij and the initial sRGB values. The color correction LUT 610 is a color conversion table that converts the SRG color space into an ink color space.

### 1.3. Prediction of Gamut Shape

When the maximum range of the gamut is not clear at the time of evaluating the base LUT 510 in the flowchart of FIG. 2, it is difficult to determine the evaluation of the generated base LUT 510. Moreover, it is difficult to set the ink amounts, the duty limit values, or the like even when the base LUT 510 is generated again. For this reason, there is a concern than the base LUT 510 may unnecessarily be generated, and thus the number of processes or processing time necessary for generating the base LUT may increase. Accordingly, in this embodiment, as indicated by a part of FIG. 2 enclosed by dotted lines, the gamut is predicted before the generation of the base LUT 510. Specifically, the gamut prediction unit 17 in FIG. 1 predicts the gamut based on the forward model (FM) and the ink duty limit values (the monochromatic color and the sum of a plurality of colors).

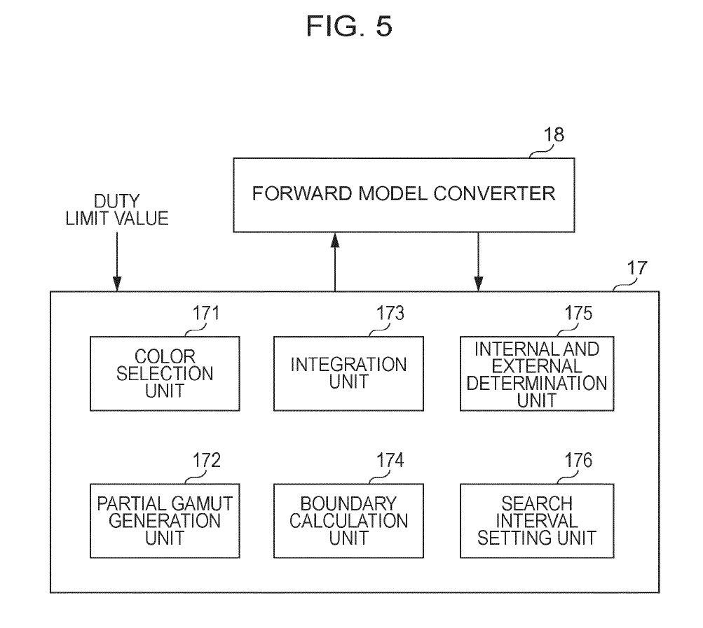

FIG. 5 is a diagram illustrating an example of the configuration of the gamut prediction unit 17. As shown in FIG. 5, the gamut prediction unit 17 includes a color selection unit 171, a partial gamut generation unit 172, an integration unit 173, a boundary calculation unit 174, an internal and external determination unit 175, and a search interval setting unit 176. The functions of these units are realized in such a manner that the CPU 12 reads programs stored in the storage unit 11, develops the programs on the RAM 13, and performs arithmetic operations in accordance with the programs.

The color selection unit 171 selects a predetermined number (in this embodiment, three kinds of) ink to generate a partial gamut among the kinds (eight kinds) of ink used in the printer 20. As described below, the actual ink amounts of three selected colors are calculated based on the duty limit values.

The partial gamut generation unit 172 generates the partial gamuts of the three kinds of selected ink based on the forward model (FM), the duty limit values of the three kinds of ink, and the sum duty limit value.

The integration unit 173 integrates the plurality of partial gamuts generated in accordance with the combination of the different inks to generate an integrated gamut.

The boundary calculation unit 174 calculates lattice points (hereinafter, also referred to as boundary points) serving as the boundary between the internal and external sides of the integrated gamut among the plurality of lattice points in the L*a*b* color space.

The internal and external determination unit 175 performs internal and external determination process to determine whether the lattice point exists inside the integrated gamut.

Based on the shape (a variation in the outline of a gamut) of the outline of the gamut, the search interval setting unit 176 sets an interval of an L* axis on which the boundary calculation unit 174 calculates the boundary point.

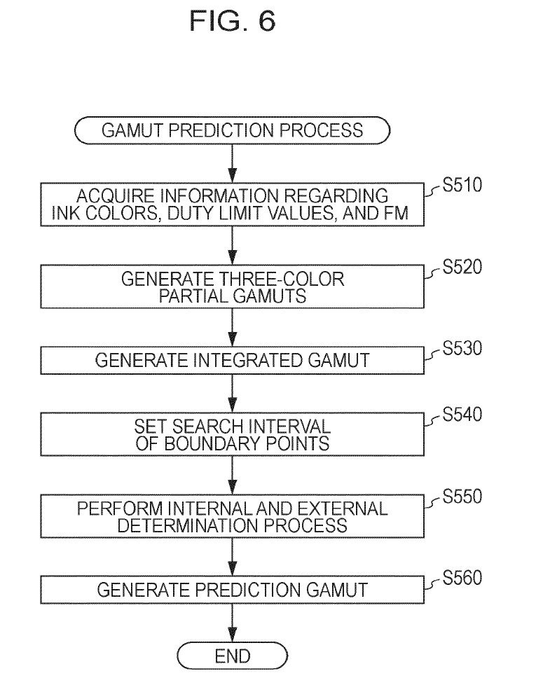

FIG. 6 is a flowchart of the gamut prediction process (step S500 of FIG. 2) according to this embodiment.

In step S510, the gamut prediction unit 17 acquires information regarding the ink colors, the duty limit values, and the forward model (FM). Further, the color selection unit 171 selects three colors from the eight kinds of ink and calculates the actual ink amounts of three selected colors in accordance with the duty limit values of a medium or a resolution. The reason for selecting three colors among the eight colors is that it is easy to perform evaluation since the gray scale values of the respective colors can be expressed three-dimensionally (stereoscopically). Moreover, the reason is to promptly generate the partial gamut described below. Further, another number of colors (for example, four colors) may be selected as well as three colors.

As for a print condition (where an image with the resolution of 1440×1440 dpi is printed on a photo sheet), the duty limit value of the monochromatic ink Lk is set to 70%, the duty limit value of the monochromatic ink LLk is set to 75%, and the others are set to 80%. When the duty limit values are converted into gray scale values (255), the gray scale value of the actual ink amount of Lk is 178.5, the gray scale value of the actual ink amount of LLk is 191.25, and the others are 204. Therefore, 512 (8×8×8) ink amount data divided into eight pieces at the same interval from 0 to the monochromatic duty limit value are generated for each ink. For example, since the maximum duty limit value of cyan is 204, a lattice interval obtained by dividing this maximum duty limit value by 7 is 29.1. That is, the gray scale value of cyan increases by 29.1 from 0. Further, the ink amount corresponding to this gray scale value is calculated. In this way, the color selection unit 171 sets the actual ink amounts of three selected colors at the same interval based on the duty limit value of each monochromatic ink.

Next, when the generation amount of ink of two or three colors exceeds the sum duty limit value, the generation amounts of respective ink are averaged and this amount of ink is lowered while maintaining the occurrence ratio of the respective inks so as not to exceed the sum duty limit value. Since permutations of selecting three colors out of the eight colors is 56, the color selection unit 171 calculates the actual occurrence amounts of respective ink for the combination of the selected three colors.

In step S520, the partial gamut generation unit 172 allows the FM converter 18 to convert the actual ink amounts described above into the L*a*b* values and generates the gamuts (partial gamuts) of the selected three colors based on the conversion result (L*a*b* values). That is, the partial gamut generation unit 172 generates the plurality of partial gamuts for the ink of the three colors by changing the combination of the ink.

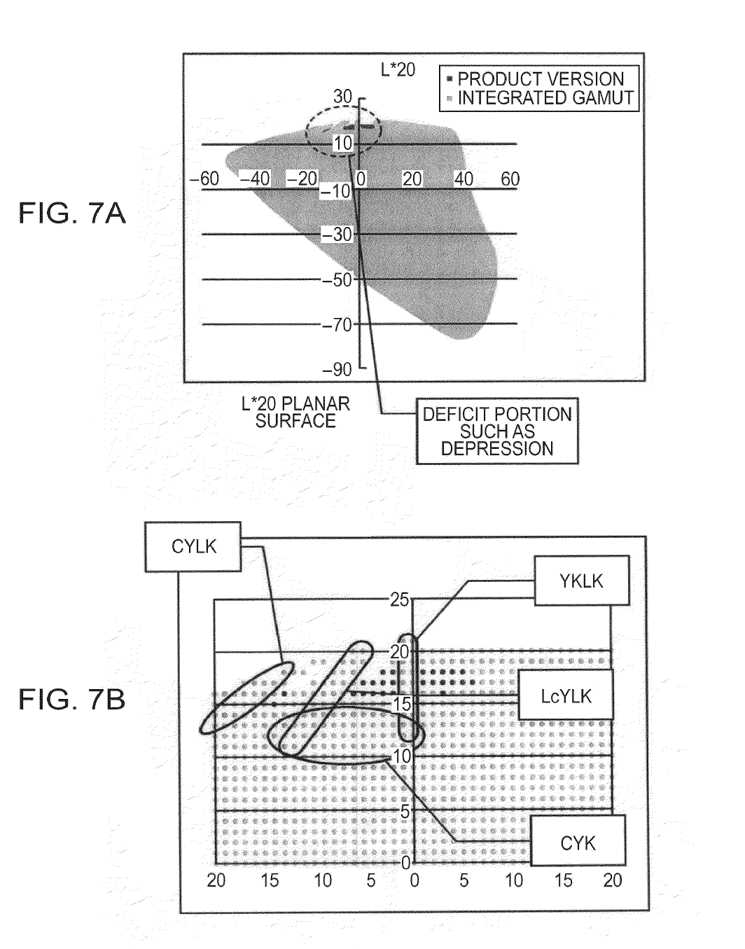

In step S530 of FIG. 6, the integration unit 173 integrates the partial gamuts generated by the combination of the different ink to generate the integrated gamut. FIGS. 7A and 7B are schematic diagrams illustrating a part of the integrated gamut. Here, FIG. 7A shows the shape of the integrated gamut on a planar surface (a*b* planar surface) of L*=20. FIG. 7B is an enlarged view of a dotted line part of FIG. 7A. In the drawings, the horizontal direction is a* (positive at the right side) and in the vertical direction is b* (positive at the upper side). In the drawings, a light gray color indicates the integrated gamut and a deep gray color indicates a product version gamut.

FIG. 7B shows the lattice points of the partial gamut for CYLk, the lattice points of the partial gamut for YKLk, the lattice points of the partial gamut for LcYLk, and the lattice points of the partial for CYK. Even the partial gamuts are added together, the partial gamuts do not cover the product version gamut.

Thus, there is a portion (deficit portion) which may not completely express the product version gamut in the integrated gamut. This is because there is an area which may not be expressed with only four colors in a color gamut. Accordingly, in this embodiment, the shape of the integrated gamut is predicted and a deficit portion is calculated in comparison to the product version gamut, as described below. Further, the deficit portion may be corrected in a process described below. However, since it takes some time to perform the internal and external determination process, the portion to be corrected is set to be the minimum.

In step S540 of FIG. 6, the boundary calculation unit 174 sets an interval at which the boundary points of the integrated gamut are calculated. Here, the boundary points are lattice points determined not to exist inside the integrated gamut (outside the integrated gamut). In this embodiment, an interval is set at which searching is performed based on a variation in the outline of the gamut.

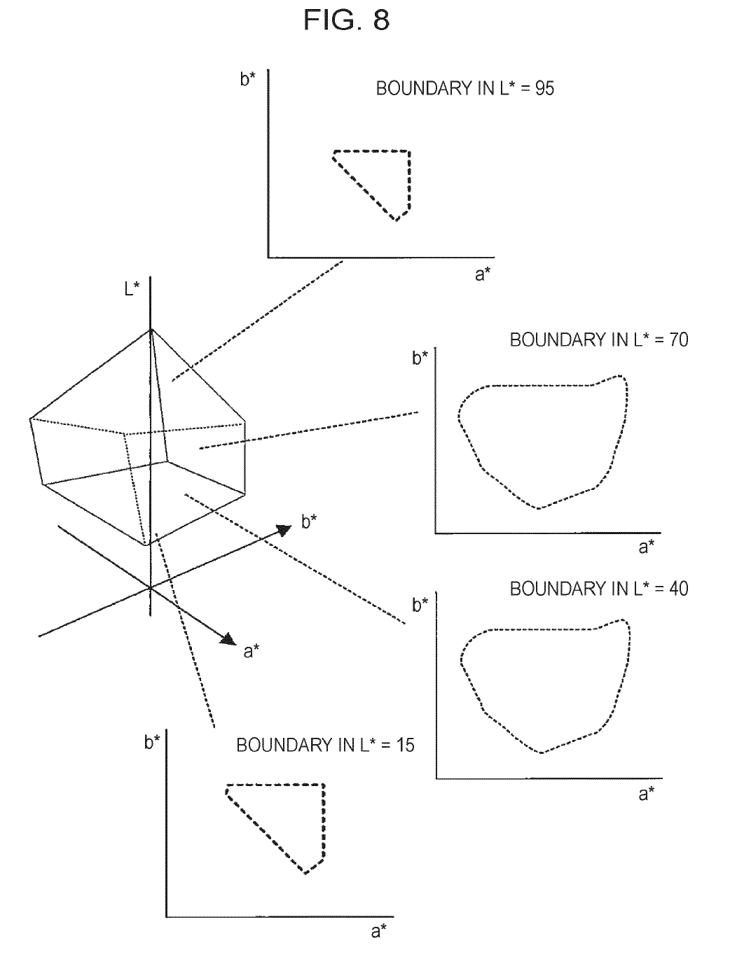

FIG. 8 is a diagram illustrating the variation in the outline of the integrated gamut. In FIG. 8, the cross-section surfaces of the L*a*b* planar surface and an a*b* planar surface are shown and each boundary is indicated by a dotted line. In FIG. 8, the variation in the outline of the gamut is small in an intermediate brightness area (20<L*<90) and the boundary in each L* planar surface is approximate. On the other hand, the variation in the outline of the gamut is noticeable in a high brightness area (L*≧90) and a low brightness area (L*≦20) and the boundary of each L* planar surface is not approximate. Thus, in the intermediate brightness area, there is no problem even when the boundary points of a predetermined L* planar surface are searched and the searched boundary points are used in other L* planar surfaces. Accordingly, it is possible to shorten the time necessary for predicting the outline of the integrated gamut by simply detecting the variation in the outline of the gamut in the L* planar surfaces and changing the interval of the L* planar surfaces searched in accordance with the variation in the outline of the gamut.

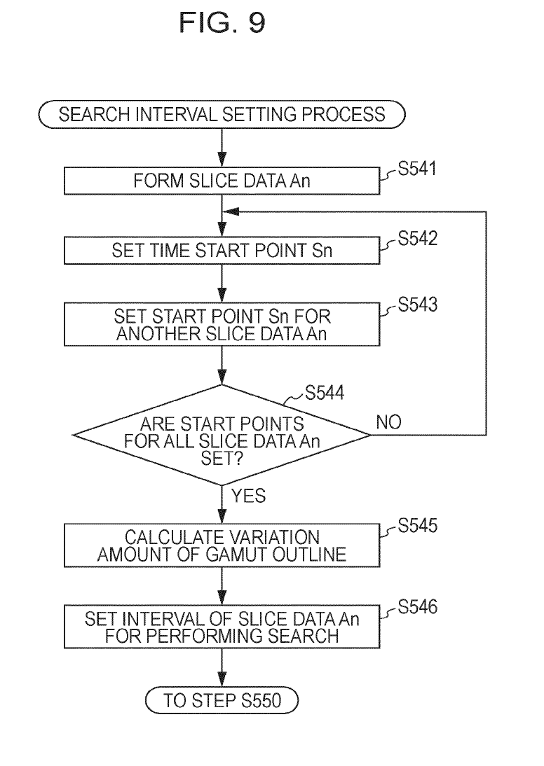

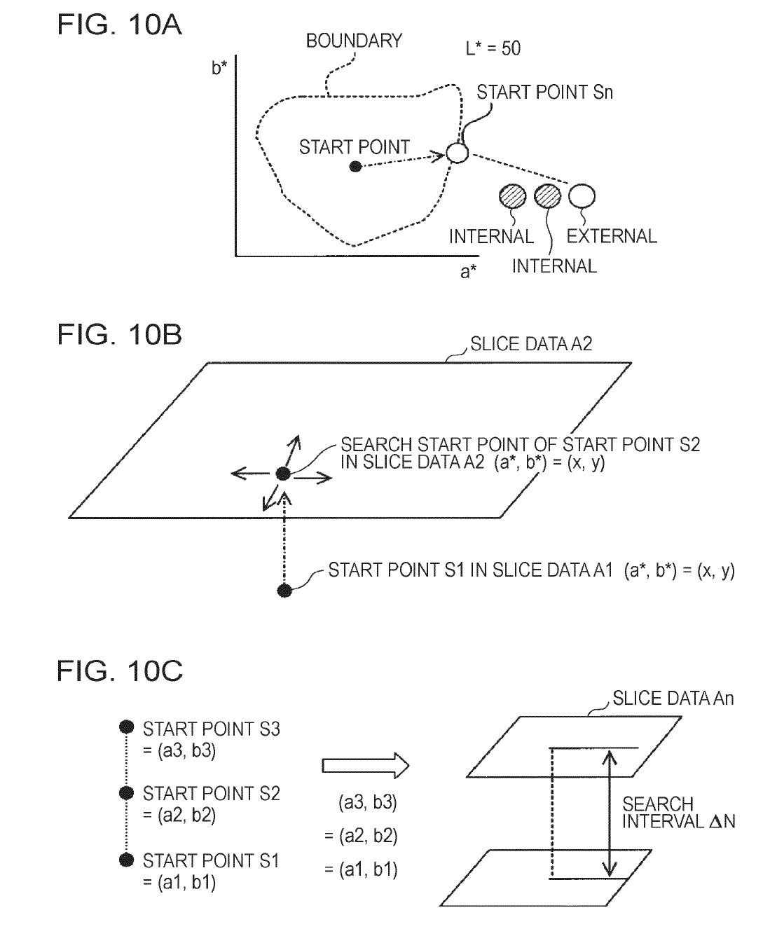

FIG. 9 is a flowchart of the process performed in step S540 of FIG. 6. FIGS. 10A to 10C are diagrams illustrating images for explaining a method of setting the search interval in step S540. In FIG. 9, the portion indicated by a dotted line on the a*b* planar surface is the boundary.

First, in step S541, the search interval setting unit 176 forms slice data An by slicing the L*a*b* space including the integrated gamut into N surfaces perpendicular to the L* axis. The slice data An is two-dimensional data of each L*=n planar surface (a*b* planar surface) including the integrated gamut. The suffix n indicates each slice data An (where n is an integer from 1 to N) formed from the high brightness area to the low brightness area. The slice number of the integrated gamut can be appropriately set. The slice number may increase in accordance with a prediction precision of the calculated gamut. In the above-described process of step S541, the target data generation process and the target data generation unit according to the invention are realized.

In step S542, the search interval setting unit 176 sets a start point Sn included in the boundary points of the integrated gamut in any of the formed slice data An (see FIG. 10A). The start point Sn is a boundary point from which the boundary calculation unit 174 starts searching for the boundary points in any slice data An. As the method of searching for the start point Sn, the internal and external determination unit 175 sets the lattice points (for example, (L*, a*, b*)=(50, 0, 0)) certainly present within the boundary in the slice data An and the search interval setting unit 176 performs internal and external determination process on three continuous lattice points toward any boundary by using this lattice point as the start point. At this time, when at least one of the three lattice points subjected to the internal and external determination process is the boundary point, two lattice points are determined as internal lattice points of the gamut and one lattice point is determined as an external lattice point (or one lattice point is determined as an internal lattice point and two lattice points are determined as external lattice points) of the gamut by the internal and external determination process. On the other hand, when all of the three lattice points are determined as the internal lattice points, the internal and external determination unit 175 moves the coordinates of the search points in a boundary direction and performs the same internal and external determination process. A specific internal and external determination method will be described below. In this embodiment, one start point Sn is used in a process described below, but the invention is not limited thereto. Any number of start points Sn may be used.

In step S543, the search interval setting unit 176 searches for the start point Sn of another slice data An adjacent in an L* axis direction. At this time, the search interval setting unit 176 sets the boundary point closest to a start point Sn′ of slice data An′ searched in the previous step as a start pint Sn′+1 of slice data An′+1. For example, when a start point S1 of slice data A1 searched in step S542 has coordinates (x, y), the search start point of a start point S2 of slice data A2 located above or below the slice data A1 in the brightness (L* axis) direction has the same coordinates (x, y) on the a*b* planar surface. When this point is determined not to exist on the boundary, the start point S2 is searched by performing the internal and external determination process on a peripheral point obtained varying the values of the coordinates (x, y) (see FIG. 10B).

When the start point Sn of all the slice data An is set in the same manner (YES in step S544), the search interval setting unit 176 calculates the variation in the outline of the gamut in a predetermined brightness area based on the set start point Sn in step S545. As the method of calculating the variation in the outline of the gamut, the variation in the outline of the gamut is determined to be small, for example, when the values of the respective coordinates (a1, b1), (a2, b2), and (a3, b3) of the start points S1=(a1, b1), S2=(a2, b2), and S3=(a3, b3) of slice data A1, A2, and A3 included in any brightness area are identical with each other (or equal to or less than a threshold value) (see FIG. 10C).

In step S546, the search interval setting unit 176 determines an interval of the slice data An subjected to the boundary search of the gamut in a predetermined brightness area based on the variation calculated in step S545. For example, when the respective coordinates of the start points S1=(a1, b1), S2=(a2, b2), and S3=(a3, b3) belonging to a given brightness area the identical with each other (or equal to or less than a threshold value), the variation in the outline of the gamut is determined to be small. Therefore, the slice data An is selected so as to enlarge a search interval AN of the slice data An subjected to the boundary search (see FIG. 10C). On the other hand, when the variation in the outline of the gamut is large (for example, the respective coordinates of the start points S1, S2, and S3 are not identical with each other or equal to or less than the threshold value), the boundaries of all of the slice data An belonging to the brightness area are searched.

Referring back to FIG. 6, in step S550, the boundary calculation unit 174 searches for the boundary points of the slice data An to be searched based on the determination of step S546. Specifically, the boundary calculation unit 174 allows the internal and external determination unit 175 to perform the internal and external determination process on the slice data An to be searched along the circumference of the boundary of the integrated gamut from the start point Sn counterclockwise by using the start point Sn as the start point of the search. The boundary point may be searched in such a manner that it is determined whether the searched lattice point is the boundary point based on three lattice points as in step S542.

In step S560 of FIG. 6, the gamut prediction unit 17 generates the prediction gamut based on the integrated gamut and the result of the internal and external determination process. That is, the boundaries of the respective slice data An to be searched are synthesized at the search interval ΔN in the respective brightness areas to predict the shape of the integrated gamut.

In this embodiment, as described above, the search interval of the boundaries is changed in accordance with the variation in the outline of the gamut when the shape of the integrated gamut is predicted. Therefore, it is possible to shorten the time necessary for predicting the shape of the gamut.

### 1.4. Internal and External Determination Process

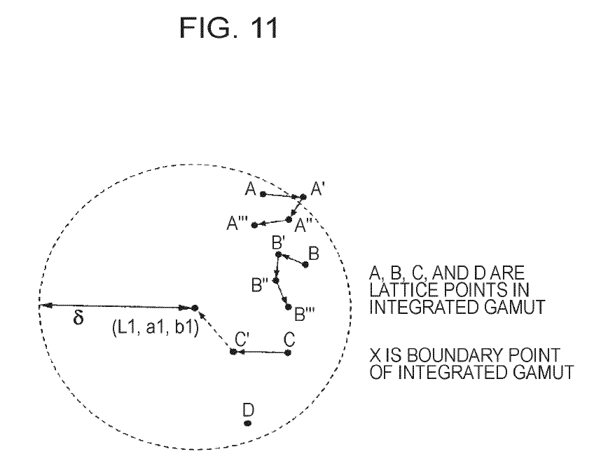

FIG. 11 is a schematic diagram illustrating the overview of the internal and external determination process. Hereinafter, an internal and external determination process performed by the internal and external determination unit 175 will be described with reference to FIG. 11. The invention is not limited to this internal and external determination process, but a general internal and external determination process may be used. In the drawing, X (L1, a1, b1) is a boundary point (lattice point outside the integrated gamut). However, since there is a deficit portion in the integrated gamut, as described above, there is a possibility that the boundary point X may exist in the integrated gamut.

Lattice points A to D are lattice points that fall within a predetermined range (δ in the drawing) in a distance from the boundary point X. Further, the lattice points A to D are the points that exist inside the integrated gamut, the lattice points A to D can expressed using the ink amounts of eight kinds of ink. The corresponding initial ink amount is set in advance in each lattice point.

The internal and external determination unit 175 performs an arithmetic operation using an optimization function to convert the ink amount corresponding to each of the lattice points (the lattice points A, B, C, and D). The converted ink amounts are converted to the L*a*b* color space by the FM converter 18. For example, the lattice A is moved to a point A′ (hereinafter, a point moved by the arithmetic operation using the optimization unction is referred to as a movement point) through this operation.

The internal and external determination unit 175 calculates a distance between the L*a*b* value of the movement point (for example, the movement point A′) obtained through the application of the optimization function and the boundary point X (L1, a1, b1) and performs a determination process (internal and external determination process) of determining whether the boundary point X exists inside the integrated gamut based on the result. The conditions where the boundary point X is determined to be inside the gamut are as follows:

(condition 1): the distance between the movement point and the boundary point X is zero or less than a threshold value (for example, 0.1);
(condition 2): the ink amount corresponding to the movement point satisfying condition 1 is within the duty limit values (the monochromatic duty limit value and the sum duty limit value); and
(condition 3): there is no negative value in the ink amount of each ink corresponding to the movement point satisfying condition 1.
When all the above conditions are satisfied, the boundary point X is determined to be a point inside the integrated gamut.

The internal and external determination unit 175 performs the process on the movement point A′ using the optimization function, when the above conditions are not satisfied in comparison between the movement point A′ and the boundary point X. In this way, the movement point A′ is moved to a movement point A″. Here, the determination is also performed based on the above conditions. When the above conditions are not satisfied, the process is further performed on the movement point A″ using the optimization function. Even when the process is reiterated predetermined number of times but the above conditions are not satisfied, the same process is performed on the other lattice points (the lattice points B, C, and D).

The internal and external determination unit 175 determines that the boundary point X exists inside the integrated gamut, when any movement point satisfies the above three conditions.

For example, the internal and external determination unit 175 determines that the boundary point X exists inside the integrated gamut, when the movement point C″ obtained by applying the optimization function to a movement point C′ in FIG. 11 is very close to the boundary point X (within the threshold value), the ink amount corresponding to the movement point C″ is within the duty limit value, and there is no negative value in each ink amount.

In this way, when the internal and external determination unit 175 determines that the boundary point X exists inside the integrated gamut, the internal and external determination unit 175 performs the same internal and external determination process on lattice points outside the boundary point X as new lattice points. The boundary of the integrated gamut is gradually corrected by reiterating the internal and external determination process. Thus, since the boundary of the integrated gamut can accurately be calculated, it is possible to improve gamut prediction precision. When the optimization function is applied to the respective lattice points (the lattice points A to D) inside the integrated gamut of the predetermined range (δ in the drawing) from the boundary point X predetermined number of times but the above conditions are not satisfied, the internal and external determination unit 175 determines that the boundary point X is not included in the integrated gamut (is outside the integrated gamut).

### 1.5. Modified Example 1

Since it is known that the variation in the outline of the gamut is small in the intermediate brightness area (for example, 20<L*<80) in the above-described integrated gamut, the search interval may be initially made to be large in the intermediate brightness area. For example, when the slice data An are generated in step S541 of FIG. 9, the interval of the slice data An in the intermediate brightness area is made to be larger than that in the high brightness area and the low brightness area. Alternatively, in step S546, the search interval in the intermediate brightness area may be set to be large. It is possible to predict the shape of the gamut faster by combining the above-described configuration with the process according to this example.

### 1.6. Modified Example 2

When the output apparatus (printing apparatus) satisfies the condition where the range of the gamut is enlarged, the interval of the slice data An searching for the boundary of the gamut may be set to be large depending on this condition. For example, when the printing apparatus uses eight kinds of ink (C, M, Y, K, Lc, Lm, Lk, and LLk), as in the embodiment, it is known that the range of the gamut is enlarged in that the color reproduction is considerably improved compared to the case where three kinds of ink (C, M, and Y) are used. Likewise, it is known that the range of the gamut is enlarged depending on the kinds of sheet (paper sheet) used in the printing apparatus. For example, it is known that the color reproduction is worse in the order of photo sheet (gloss sheet)>mat sheet>normal sheet of the sheets to be used. On the other hand, when the color reproduction is improved, the considerably varied area becomes small in the gamut. Therefore, when the printing apparatus satisfies the above conditions where the range of the gamut is enlarged, the interval of the slice data An may be made to be large at the time of generating the slice data An. It is possible to further shorten the time necessary for predicting the shape of the gamut by combining the above-described configuration with the process according to this example.

### 2. Second Embodiment

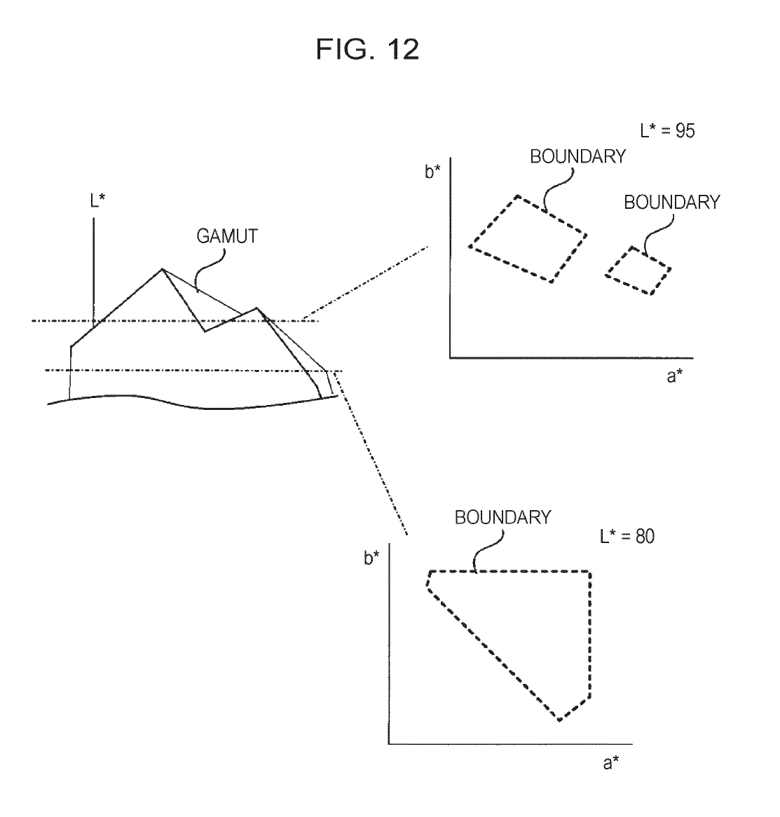

An area formed in the L*=n planar surface (a*b* planar surface) of a predetermined bright area is divided in some cases. FIG. 12 is a perspective view illustrating a part of the high brightness area of the integrated gamut. For example, the integrated gamut shown in FIG. 12 is diverged into two gamuts in the brightness area higher than L*=90. That is, one boundary is developed on the a*b* planar surface of the slice data L*90 in L*=90 (see the lower part of FIG. 12) whereas two boundaries are developed on the a*b* planar surface of the slice data L*92 in L*=92 (see the upper part of FIG. 12). In this case, in a method of predicting the shape of the gamut according to this embodiment, only one area of any slice data L*n is determined in some cases. Accordingly, in the second embodiment, the algorithm for the boundary search is changed for the brightness area so as to deal with the division of the boundary.

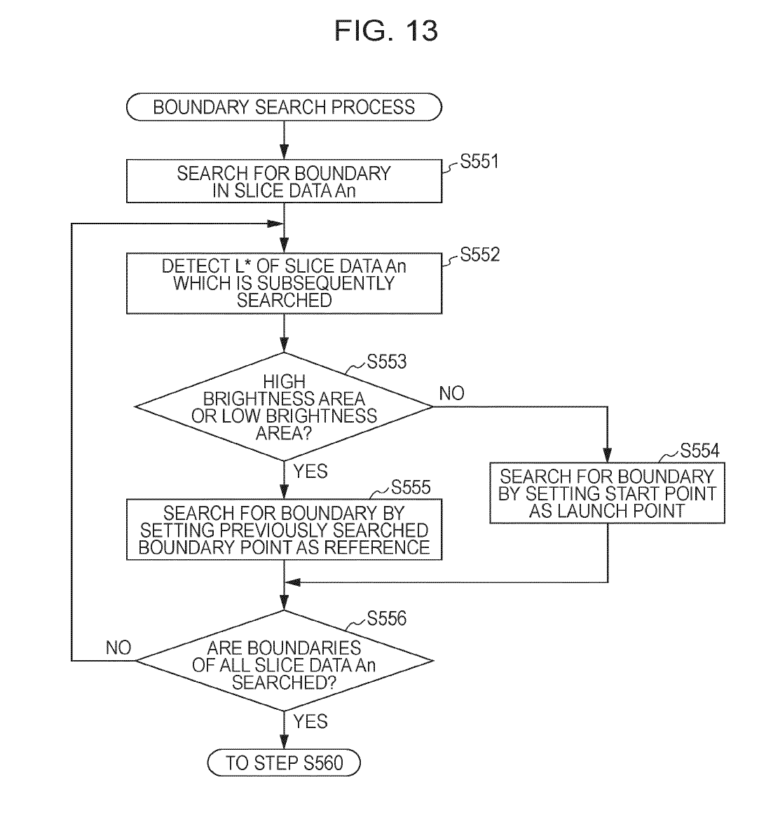

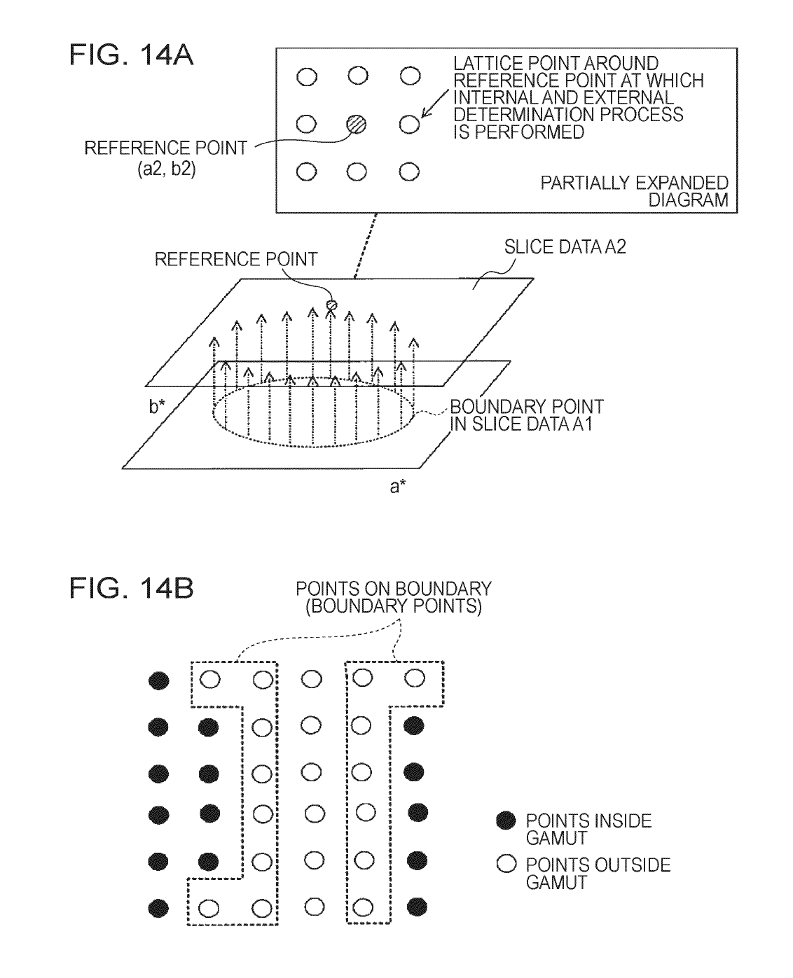

FIG. 13 is a flowchart of a process performed in step S550 of FIG. 6 according to the second embodiment. FIGS. 14A and 14B are diagrams of a boundary search process performed according to the second embodiment.

In step S551, the boundary calculation unit 174 searches all the boundary points of the boundary of the slice data An to be searched by allowing the internal and external determination unit 175 to perform the internal and external determination process. For example, the boundary search is performed on the slice data L*50 on the L*=50 planar surface.

In step S552, the boundary calculation unit 174 detects the L* value of the slice data An to be subsequently searched. Since the area where the gamut is diverged is the high brightness area or the low brightness area in many cases, it is determined in the process of step S552 whether the slice data An to be subsequently searched belongs to the high brightness area or the low brightness area.

In step S553, when the L* value of the slice data An determined in step S552 is the high brightness area or the low brightness area (YES in step 553), the boundary calculation unit 174 allows the process to step S555. In the processes after step S555, the boundary calculation unit 174 changes the algorithm for the boundary search, since there is a high possibility that two or more boundaries exist in the slice data An. Further, when the L* value of the slice data An is the intermediate brightness area (NO in step S553), the process proceeds to step S554 in that only one boundary exists in the slice data An. The boundary calculation unit 174 performs the boundary search by setting the start point Sn as a launch point, as in the first embodiment.

In step S555, the boundary calculation unit 174 performs the internal and external determination process near N (where N is an integer) of the slice data An′+1 by setting all the boundary points on the boundary of the slice data An′ searched in step S551 as reference points. For example, the boundary point (a1, b1) searched for the slice data A1 is set as a reference, the lattice point in the slice data A2 moved upward (downward) from this boundary point in the L* axis direction is set as a reference point (a1, b1), and the internal and external determination process is performed on nine lattice points including the reference point (a1, b1) (see FIG. 14A).

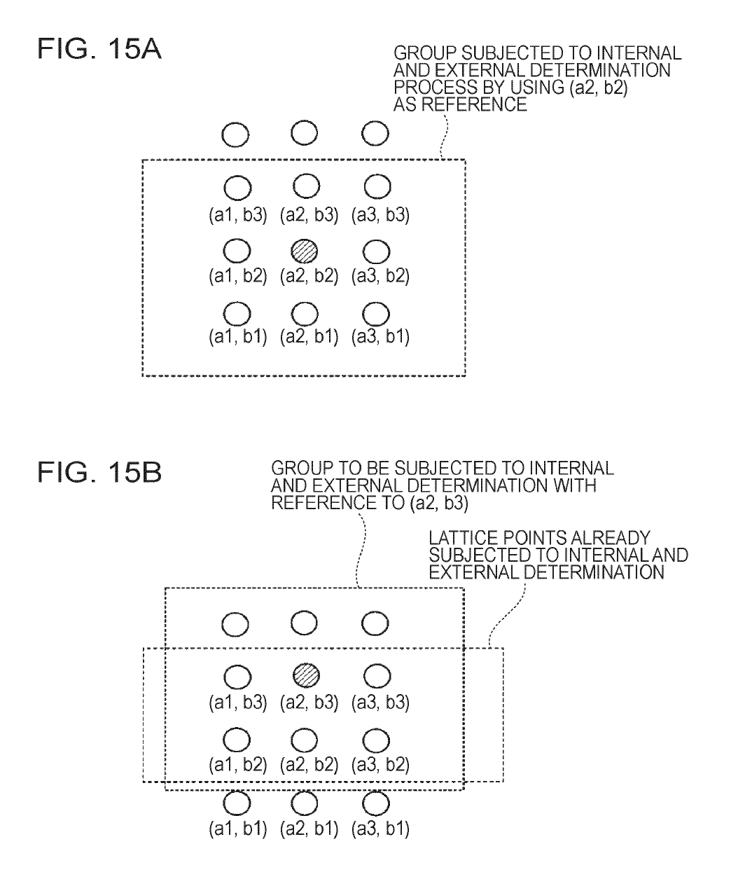

At this time, the internal and external determination process is not performed on all the N lattice points by setting all the boundary points searched previously on the same slice data An as a reference. Instead, the results obtained by performing the internal and external determination process on the respective lattice points may be stored and may be used in the subsequent internal and external determination process on the lattice points. FIGS. 15A and 15B are diagrams of the internal and external determination process according to the second embodiment. For example, it is assumed that the internal and external determination process is performed on nine lattice points (a1, b1), (a2, b1), (a3, b1), (a1, b2), (a2, b2), (a3, b2), (a1, b3), (a2, b3), and (a3, b3) by setting the lattice point (a2, b2) as a reference point (see FIG. 15A). Then, when the lattice (a2, b3) is set as the reference point in the subsequent group to be subjected to the internal and external determination process, the lattice points (a1, b2), (a2, b2), (a3, b2), (a1, b3), (a2, b3), and (a3, b3) have already been subjected to the internal and external determination process previously. Therefore, in the internal and external determination process of setting the lattice point (a2, b3) as the reference point, the internal and external determination process is performed on only the lattice points other than the above-mentioned lattice points. As a consequence, it is possible to reduce the number of lattice points subjected to the internal and external determination process (see FIG. 15B).

Since the coordinates of all the boundary points searched for the slice data An′ are set as the reference points and the internal and external determination process is performed on N lattice points around each reference point through the above-described series of internal and external determination processes, the internal and external determination process can be performed on the lattice points included in the slice data An′+1 without omission. Therefore, even when the boundary is divided, the boundary points on each boundary can be searched (see FIG. 14B). A step of calculating the boundary points and a boundary calculation unit according to the invention are realized through the process from step S552 to step S555.

In step S556, the boundary calculation unit 174 returns the process to step S552 and reiterates the processes to step S555, when the boundary search is not performed on all the slice data An to be searched (NO in step S556). At this time, for example, the boundary search is performed on the slice data An in the order in which the brightness increases from the L*=50 planar surface as the boundary search start position of the slice data An to be searched. Then, when the boundary search of all the slice data An with brightness higher than that of the L*50=planar surface ends, the boundary search start position returns to the L*=50 planar surface, and then the search boundary may be performed on the slice data An to be searched in the order in which the brightness decreases.

Subsequently, when the boundary search is performed on all the slice data An to be searched (YES in step S556), the process proceeds to step S560 of FIG. 6 and the gamut prediction unit 17 generates the prediction gamut based on the integrated gamut and the result of the internal and external determination process. A step of predicting the shape of the gamut and a gamut shape prediction unit according to the invention are realized through the process of step S560.

In the second embodiment, as described above, the boundary search can be performed appropriately even when the boundary is divided in given slice data An by changing the algorithm for the boundary search in the brightness area where the gamut is diverged. Further, in the brightness area where the gamut is not divided, the above described processes according to the first embodiment may be performed. Accordingly, it is possible to shorten the time necessary for predicting the shape of the gamut. The second embodiment has hitherto been described.

### 3. Other Embodiments

In the above-described embodiments, the output apparatus has mainly been described as a printer. Of course, the invention includes disclosures of a printing apparatus, a recording apparatus, a liquid ejecting apparatus, a printing method, a recording method, a liquid ejecting method, a printing system, a recording system, a computer system, a program, a storage medium storing the program, a display screen, a screen display method, a print product manufacturing method, and the like.

The above-described embodiments have been described for facilitating the understanding of the invention, but are not construed as limiting of the invention. The invention is altered and improved without departing from the gist of the invention and, of course, includes the equivalents of the invention. In particular, the above-described embodiments are included in the invention.

What is claimed is:

1. A gamut shape prediction method of predicting a shape of a gamut expressed on a predetermined color space using a computer, comprising:
forming a plurality of target data which represents a cross-section surface along a first axis in the predetermined color space where the gamut is formed and which is used to search for boundary points of the gamut;
calculating the boundary points of the target data by setting all boundary points of the target data located above or below along the first axis as references; and
predicting the shape of the gamut from the calculated boundary points of each target data.

2. The gamut shape prediction method according to claim 1, wherein in the calculating of the boundary points, the boundary points are calculated by performing an internal and external determination process of setting, as start points, lattice points perpendicular in a direction of the first axis to all the boundary points of the target data located above or below in the direction of the first axis and determining whether each start point and lattice points around each start point exist inside or outside the gamut.

3. The gamut shape prediction method according to claim 2, wherein in the calculating of the boundary points, results of the internal and external determination process performed on the respective lattice points are recorded and used in subsequent searching of the boundary points of the same target data.

4. The gamut shape prediction method according to claim 1,
wherein the color space is an L*a*b* color space and the first axis is an L* axis, and
wherein the calculating of the boundary points is performed in a high brightness area and a low brightness area.

5. The gamut shape prediction method according to claim 1, wherein when the output apparatus satisfies a condition where a range of the gamut increases, an interval of the target data for searching for the boundary points is enlarged.

6. A gamut shape prediction program causing a computer to predict a shape of a gamut expressed on a predetermined color space for an output apparatus and causing the computer to realize:
a target data forming unit forming a plurality of target data which represents a cross-section surface along a first axis in the predetermined color space where the gamut is formed and which is used to search for boundary points of the gamut;
a boundary point calculation unit calculating the boundary points of the target data by setting all boundary points of the target data located above or below along the first axis as references; and
a gamut shape prediction unit predicting the shape of the gamut from the calculated boundary points of each target data.

7. A printing apparatus including a color conversion table formed using a gamut predicted by the gamut shape prediction method according to claim 1.

8. A printing apparatus including a color conversion table formed using a gamut predicted by the gamut shape prediction method according to claim 2.

9. A printing apparatus including a color conversion table formed using a gamut predicted by the gamut shape prediction method according to claim 3.

10. A printing apparatus including a color conversion table formed using a gamut predicted by the gamut shape prediction method according to claim 4.

11. A printing apparatus including a color conversion table formed using a gamut predicted by the gamut shape prediction method according to claim 5.
